(19) United States
(12) Patent Application Publication
(10) Pub. No.: US 2009/0136847 A1
(43) Pub. Date: May 28, 2009

(54) NEGATIVE ACTIVE MATERIAL FOR RECHARGEABLE LITHIUM BATTERY, AND METHOD OF PREPARING THE SAME

(76) Inventors: Goo-Jin Jeong, Suwon-si (KR); Sang-Min Lee, Suwon-si (KR); Wan-Uk Choi, Suwon-si (KR); Hun-Joon Sohn, Suwon-si (KR)

Correspondence Address: CHRISTIE, PARKER & HALE, LLP, PO BOX 7068, PASADENA, CA, 91109-7068, US

(21) Appl. No.: 12/251,315

(22) Filed: Oct. 14, 2008

(30) Foreign Application Priority Data
Nov. 27, 2007 (KR) 10-2007-0121726

(51) Int. Cl. H01M 4/58

(52) U.S. Cl. 429/218.1

(57) ABSTRACT

A negative active material for a rechargeable lithium battery with a composite phase particle has a chemical formula, SiOₓ, where 0<x<1. The material comprises a first crystalline phase of Si nano-grains, and a second phase of non-crystalline SiO₂, where the composite phase particle has a Si-phase peak of 150 to 480 cm⁻¹ according to Raman spectroscopic analysis.

### CROSS-REFERENCE TO RELATED APPLICATION

This application claims priority to and the benefit of Korean Patent Application No.10-2007-0121726 filed in the Korean Intellectual Property Office on Nov. 27, 2007, the entire content of which is incorporated herein by reference.

### FIELD OF THE INVENTION

The present invention relates to negative active materials for rechargeable lithium batteries and methods of preparing the same.

### BACKGROUND OF THE INVENTION

Lithium rechargeable batteries have recently drawn attention as power sources for small portable electronic devices. These batteries use organic electrolyte solutions and therefore have discharge voltages that are twice as high as conventional batteries using alkali aqueous solutions. Accordingly, lithium rechargeable batteries have high energy densities.

Lithium-transition element composite oxides being capable of intercalating lithium, such as LiCoO₂, LiMn₂O₄, LiNiO₂, LiNi₁₋ₓCoₓO₂ (0<x<1), and so on, have been researched for use as positive active materials for lithium rechargeable batteries.

Various carbon-based materials, such as artificial graphite, natural graphite, and hard carbon, all of which can intercalate and deintercalate lithium ions, have been used as negative active materials. The use of graphite tends to increase battery discharge voltages and energy densities because it has a low discharge potential of −0.2V compared to lithium. Batteries using graphite as the negative active material have high average discharge potential of 3.6V and excellent energy densities. Furthermore, graphite is the most commonly used of the aforementioned carbon-based materials because graphite imparts better cycle-life due to its outstanding reversibility. However, when used as negative active materials, graphite active materials have low densities and consequently low capacity in terms of energy density per unit volume. Further, there is some danger of explosion or combustion when a battery is misused, overcharged, or the like, because graphite is likely to react with the organic electrolyte at high discharge voltages.

To address these problems, research on tin oxide and lithium vanadium oxide has recently been conducted for use in negative electrodes. For example, amorphous tin oxide has high capacity per weight (800 mAh/g). However, amorphous tin oxide has high initial irreversible capacity up to 50%. Furthermore, tin oxide has a tendency to be reduced to tin metal during the charge or discharge reaction, rendering it disadvantageous for use in a battery.

In another oxide negative electrode, LiₐMg_{b}VO_{c} (0.05≦a≦3, 0.12≦b≦2, 2≦2c-a-2b≦5) has been used as the negative active material. However, such oxide negative electrodes do not impart sufficient battery performance and therefore further research into oxide negative materials has been conducted.

### SUMMARY OF THE INVENTION

One embodiment of the present invention provides a negative active material for rechargeable lithium batteries that has an improved initial efficiency and cycle-life characteristics by suppressing its initial irreversible reaction.

Another embodiment of the present invention provides a negative electrode and a rechargeable lithium battery that includes the negative active material. According to one embodiment of the present invention, the negative active material for rechargeable lithium batteries includes a composite phase particle of the form SiOₓ, a first crystalline phase of a Si nano-grain and a second phase of non-crystalline SiO₂, where 0<x<1, and the composite phase particle has a Si-phase peak of 150 to 480cm⁻¹ according to a Raman spectroscopic analysis.

According to another embodiment of the present invention, there is provided a rechargeable lithium battery with a negative electrode having the negative active material.

The negative active material for a rechargeable lithium battery according to the present invention can improve initial capacity, initial efficiency, and cycle-life characteristics by suppressing its initial irreversible reaction.

### BRIEF DESCRIPTION OF THE DRAWINGS

The above and other features of the present invention will become more apparent by reference to the following detailed description when considered in conjunction with the attached drawings, in which:

FIG. 1 is a schematic cross-sectional view showing a negative electrode of a lithium rechargeable battery according to one embodiment of the present invention.

FIG. 2 is a cross-sectional perspective view of a rechargeable lithium battery according to one embodiment of the present invention.

FIG. 3 is a graph depicting the results of an X-ray diffraction analysis of a negative active material prepared according to Example 1.

### DETAILED DESCRIPTION OF THE INVENTION

A typical rechargeable lithium battery includes a carbon-based material as a negative active material. However, the carbon-based material has limited capacity. Therefore, various alternatives for the carbon-based material have been researched to increase the capacity. For example, lithium metal has been suggested as an alternative because of its high energy density. However, the lithium metal has safety problems due to growth of dendrites and a shortened cycle-life as the battery is repeatedly charged and discharged.

Accordingly, lithium alloys have been suggested as another alternative. Lithium alloys have high-capacity and are capable of replacing lithium metal. Among materials which may be alloyed with lithium, Si has a theoretical maximum capacity of 4000 mAh/g. However, Si can crack easily due to volume changes during the discharge and charge cycles. As a result, active material particles can be destroyed, thereby decreasing the battery capacity and cycle-life.

Accordingly, various efforts have been made to prevent decreased cycle-life due to mechanical deterioration. For example composite active materials including a material that reacts with lithium and a material that does not react with lithium have been suggested to address the cycle-life concern.

In the present invention, silicon oxide (SiO₂) in the negative active material has an oxygen content that is irreversibly reacted and therefore does not adversely impact the initial efficiency of the battery. In addition, the crystallinity in the negative active material is reduced, thereby improving cycle-life characteristics.

The negative active material for rechargeable lithium batteries according to one embodiment of the present invention includes a composite phase particle of Formula 1. The composite phase particle includes a first crystalline phase of a Si nano-grain and a second phase of non-crystalline SiO₂. The composite phase particle has a Si-phase peak of 150 to 480cm⁻¹ according to Raman spectroscopic analysis.

SiOₓ Chemical Formula 1

In the above formula, x is an atomic ratio of oxygen relative to silicon. In one embodiment, x is such that 0<x<1. In another embodiment, x is in the range of 0.2≦x≦0.8.

The negative active material can be obtained by alloying a first crystalline phase of Si nano-grain having an average particle diameter of 10 nm or less with a second phase of a non-crystalline SiO₂ by deposition processes. According to one embodiment, the amorphous or low crystalline characteristic suppresses the initial irreversible reaction of the negative active material.

The negative electrode oxide exhibits a Si-phase peak of 150 to 480 cm⁻¹ according to Raman spectroscopic analysis. When the Si-phase peak deviates from this range, more grains having large particle diameters are produced, which can cause cracks during the volume expansion and contraction, thereby deteriorating the cycle-life characteristics.

The negative active material exhibits a Si(111) plane diffraction peak having a full width at half maximum (FWHM) of 0.5°(degrees) or more according to X-ray diffraction analysis (CuKα). In one embodiment, the Si(111) plane diffraction peak has a full width at half maximum (FWHM) of 0.8°(degrees). If the Si(111) plane diffraction peak has a full width at half maximum (FWHM) of less than 0.5°, more Si grains having larger particle diameters are produced, which can cause cracks during the volume expansion and contraction, thereby deteriorating the cycle-life characteristics.

According to one embodiment, the negative active material has an average particle size ranging from 0.1 to 100 μm. In another embodiment, the negative active material has an average particle size ranging from 1 μm to 20 μm. When the average particle diameter of the negative active material is less than 0.1 μm, the electrode plate density may decrease. When the average particle diameter of the negative active material is more than 100 μm, the rate-capability may deteriorate.

In an embodiment, the negative active material has a specific surface area ranging from 1 m²/g to 100 m²/g. According to one embodiment, the negative active material has a specific surface area ranging from 1 m²/g to 50 m²/g. When the negative active material has a specific surface area less than 1 m²/g, the rate-capability may deteriorate. When the specific surface area is more than 100 m²/g, undesirable side-reactions can occur.

The negative active material having the above-mentioned characteristics may be prepared by depositing a silicon-containing compound.

Several examples of deposition processes include, but are not limited to, chemical vapor deposition, pyrolytic deposition, laser deposition, electron beam deposition, ion plating, and magnetron sputtering. In addition, chemical vapor deposition can include plasma chemical vapor deposition, thermo-chemical vapor deposition, and the like.

In one embodiment, the negative active material may be prepared by chemical vapor deposition using a silicon-containing compound.

The silicon-containing compound may be selected from the group consisting of monosilane, silicon-containing oxides, silicon-containing chlorides, and combinations thereof.

The silicon-containing compound may be in a gas-phase. In one embodiment, it may be mixed with an oxidizing gas such as oxygen, chlorine, carbon dioxide, or air.

The silicon-containing compound in a gas-phase may be mixed with an oxidizing gas at a volume ratio ranging from 0.5:1 to 2:1. In one embodiment, the silicon-containing compound in a gas-phase and the oxidizing gas are mixed at a volume ratio ranging from 1:1 to 1.5:1. When the silicon-containing compound in a gas-phase is mixed with the oxidizing gas at a volume ratio that deviates from this range and the oxidizing gas is excessively high, excess SiO₂ can be generated. When there is an insufficient amount of oxidizing gas, excess crystalline Si can be generated.

According to one embodiment, the silicon-containing compound is deposited by chemical vapor deposition under an inert atmosphere such as with argon gas, for example.

In one embodiment, the chemical vapor deposition is carried out under a pressure of 10 to 1000 kPa. In another embodiment, the chemical vapor deposition is carried out under a pressure of 20 to 500 kPa. When the deposition is carried out under a pressure of less than 10 kPa, the reaction may not occur. When the deposition is carried out under a pressure of more than 1000 kPa, excess crystalline Si may be generated.

In one embodiment, the chemical vapor deposition is performed at a temperature ranging from 500 to 1000° C. In another embodiment, the deposition is performed at a temperature ranging from 600 to 800° C. When the deposition temperature is less than 500° C., the reaction may not occur. When the temperature is more than 1000° C., excess crystalline Si may be generated.

The negative active material according to one embodiment of the present invention may be prepared by deposition of solid monosilane and a solid silicon-containing compound.

The monosilane and the silicon-containing compound can be added at a mole ratio ranging from 1:1.5 to 2:1.

Each of the monosilane and the silicon-containing compound is mounted in a separate target device. The monosilane is deposited at a temperature ranging from 1800 to 2500° C., and the silicon-containing compound is deposited at a temperature ranging from 1000 to 1700° C.

The atmosphere in the reaction bath may be an inert atmosphere containing an inert gas such as argon. In one embodiment, the deposition is carried out under a pressure ranging from 10 to 500 kPa.

Silicon oxide (SiO₂) in the negative active material for a rechargeable lithium battery has an oxygen content that is irreversibly reacted, and therefore, does not adversely impact the initial efficiency of the battery. In addition, the crystallinity in the negative active material is reduced, thereby improving cycle-life characteristics.

According to another embodiment of the present invention, a negative electrode is provided including the negative active material.

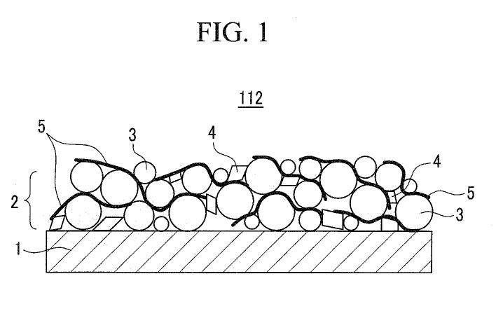

Referring to FIG. 1, the negative electrode 112 includes a current collector 1 and an active material layer 2 disposed on the current collector 1.

The current collector 1 may be selected from the group consisting of copper foil, nickel foil, stainless steel foil, titanium foil, nickel foam, copper foam, and polymer materials coated with conductive metal.

The active material layer 2 includes a negative active material 3, a binder 5, and a conductive material 4.

The negative active material 3 is the same as was described above, and may be included in an amount ranging from 1 to 99 wt % based on the total weight of the negative active material layer 2. In one embodiment, the negative active material is included in an amount ranging from 10 to 98 wt % based on the total weight of the negative active material layer 2. When the negative active material is outside of this range, capacity may deteriorate, or the relative amount of binder maybe reduced, thereby deteriorating the adherence between the negative active material layer and the current collector.

The binder 5 improves binding properties of the particle-type negative active material 3 to itself and to a current collector. Examples of suitable binders include, but are not limited to, polyvinylalcohol, carboxylmethyl cellulose, hydroxypropylene cellulose, diacetylene cellulose, polyvinylchloride, carboxylated polyvinylchloride, polyvinyldifluoride, ethylene oxide-containing polymers, polyvinylpyrrolidone, polyurethane, polytetrafluoroethylene, polyvinylidene fluoride, polyethylene, polypropylene, styrene-butadiene rubbers, acrylated styrene-butadiene rubbers, epoxy resins, and nylon.

The binder may be included in an amount from 1 to 20 wt % based on the total weight of the negative active material layer 2. In one embodiment, the binder may be included in an amount from 2 to 10 wt % based on the total weight of the negative active material layer 2. When the amount of the binder is less than 1 wt %, sufficient adherence cannot be obtained, while when it is more than 20 wt %, capacity may deteriorate.

The negative active material layer may further include a conductive material 4 to improve electrical conductivity of the negative electrode and to act as a lubricant between the active material particles, thereby improving electrode expansion and cycle-life characteristics.

Any electrically conductive material 4 can be used so long as the material does not cause a chemical change. Nonlimiting examples of suitable conductive materials include natural graphite, artificial graphite, carbon black, acetylene black, ketjen black, phenylene derivatives, carbon fibers, metal powders or metal fibers including copper, nickel, aluminum, silver, and so on.

The conductive material may be provided in any one or more or various shapes such as particles, flakes, and fiber, but the shape is not limited thereto.

The conductive material 4 may be included in an amount of 20 wt % or less based on the total weight of the negative active material layer 2. In one embodiment, the conductive material 4 may be included in an amount from 1 to 10 wt % based on the total weight of the negative active material layer 2. When the amount of the conductive material is more than 20 wt %, the electrode energy density may deteriorate.

The above-mentioned negative electrode 112 is provided by mixing a negative active material 3, optionally a conductive material 4, and a binder 5 in a solvent to obtain a composition for a negative active material layer, and coating the composition on a current collector. Methods of manufacturing electrodes are well known in this art, so a detailed description is omitted. The solvent may include N-methylpyrrolidone, but it is not limited thereto.

The negative electrode having the above structure can be applied to a rechargeable lithium battery.

The rechargeable lithium battery includes a negative electrode, a positive electrode including a positive active material that is capable of intercalating and deintercalating lithium ions, and an electrolyte, which includes a non-aqueous organic solvent and a lithium salt.

Rechargeable lithium batteries can be classified as lithium ion batteries, lithium ion polymer batteries, and lithium polymer batteries based on the presence of a separator and the types of electrolyte used in the battery. Rechargeable lithium batteries may have a variety of shapes and sizes, which include cylindrical, prismatic, or coin-type shape. They can also be a thin-film type battery or a bulk-type battery. Structures and fabricating methods for lithium ion batteries pertaining to the present invention are well known in the art.

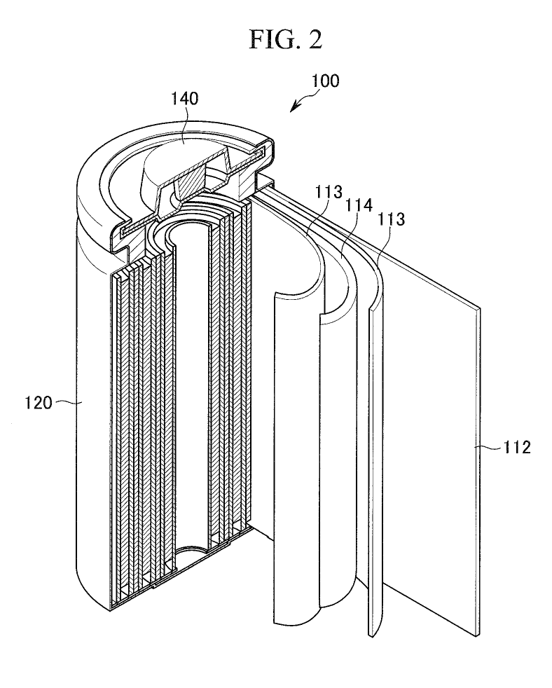

FIG. 2 shows a rechargeable lithium battery 100 according to one embodiment of the present invention. The rechargeable lithium battery 100 includes a negative electrode 112, a positive electrode 114, a separator 113 interposed between the negative electrode 112 and the positive electrode 114, an electrolyte impregnating the separator 113, a battery case 120, and a sealing member 140 sealing the battery case 120.

The negative electrode 112 is the same as previously described above.

The positive electrode 114 includes a current collector, and a positive active material layer disposed on the current collector.

The positive active material layer may include a positive active material, for example a lithiated intercalation compound that is capable of reversibly intercalating and deintercalating lithium ions. Nonlimiting examples of suitable lithiated intercalation compounds include compounds of the following Chemical Formulas 2 to 25.

LiₐA_{1-b}B_{b}D₂ Chemical Formula 2

where, 0.95≦a≦1.1 and 0≦b≦0.5.

LiₐE_{1-b}B_{b}O_{2-c}F_{c} Chemical Formula 3

where, 0.95≦a≦1.1, 0≦b≦0.5, and 0≦c≦0.05.

LiE_{2-b}B_{b}O_{4-c}F_{c} Chemical Formula 4

where, 0≦b≦0.5 and 0≦c≦0.05.

LiₐNi_{1-b-c}Co_{b}BcD_{α} Chemical Formula 5

where, 0.95≦a≦1.1, 0≦b≦0.5, 0≦c≦0.05, and 0<α≦2.

LiₐNi_{1-b-c}Co_{b}B_{c}O_{2-α}F_{α} Chemical Formula 6

where, 0.95≦a≦1.1, 0≦b≦0.5, 0≦c≦0.05, and 0<α<2.

LiₐNi_{1-b-c}Co_{b}B_{c}O_{2-α}F₂ Chemical Formula 7

where, 0.95≦a≦1.1, 0≦b≦0.5, 0≦c≦0.05, and 0<α<2.

LiₐNi_{1-b-c}Mn_{b}B_{c}D_{α} Chemical Formula 8

where, 0.95≦a≦1.1, 0≦b≦0.5, 0≦c≦0.05, and 0<α≦2.

LiₐNi_{1-b-c}Mn_{b}B_{c}O_{2-α}F_{α} Chemical Formula 9

where,0.95≦a≦1.1, 0≦b≦0.5, 0≦c≦0.05,and 0<α<2.

LiₐNi_{1-b-c}Mn_{b}B_{c}O_{2-α}F₂ Chemical Formula 10

where, 0.95≦a≦1.1, 0≦b≦0.5, 0≦c≦0.05, and 0<α<2.

LiₐNi_{b}E_{c}G_{d}O₂ Chemical Formula 11

where, 0.90≦a≦1.1, 0≦b≦0.9, 0≦c≦0.9, and 0.001≦d≦0.1.

LiₐNi_{b}Co_{c}Mn_{d}GₑO₂ Chemical Formula 12

where,0.90≦a≦1.1, 0≦b≦0.9, 0≦c≦0.5, 0≦d≦0.5, and 0.001≦e≦0.1.

LiₐNiG_{b}O₂ Chemical Formula 13

where, 0.90≦a≦1.1 and 0.001≦b≦0.1.

LiₐCoG_{b}O₂ Chemical Formula 14

where, 0.90≦a≦1.1 and 0.001≦b≦0.1.

LiₐMnG_{b}O₂ Chemical Formula 15

where, 0.90≦a≦1.1 and 0.001≦b≦0.1.

LiₐMn₂G_{b}O₄ Chemical Formula 16

where, 0.90≦a≦1.1 and 0.001≦b≦0.1.

QO₂ Chemical Formula 17

QS₂ Chemical Formula 18

LiQS₂ Chemical Formula 19

V₂O₅ Chemical Formula 20

LiV₂O₅ Chemical Formula 21

LiIO₂ Chemical Formula 22

LiNiVO₄ Chemical Formula 23

Li_{(3-f)}J₂(PO₄)₃ (0≦f<3) Chemical Formula 24

Li_{(3-f)}Fe₂(PO₄)₃ (0≦f≦2) Chemical Formula 25

In Chemical Formulas 2 to 25 above, A is selected from the group consisting of Ni, Co, and Mn; B is selected from the group consisting of Al, Ni, Co, Mn, Cr, Fe, Mg, Sr, V, and rare earth elements; D is selected from the group consisting of O, F, S, and P; E is selected from the group consisting of Co, and Mn; F is selected from the group consisting of F, S, and P; G is selected from the group consisting of Al, Cr, Mn, Fe, Mg, La, Ce, Sr, V, and lanthanide elements; Q is selected from the group consisting of Ti, Mo, and Mn; I is selected from the group consisting of Cr, V, Fe, Sc, and Y; and J is selected from the group consisting of V, Cr, Mn, Co, Ni, and Cu.

In one embodiment, the positive active material may include inorganic sulfur (S₈, elemental sulfur) and/or a sulfur-based compound. The sulfur-based compound may include Li₂Sₙ (n≧1), Li₂Sₙ (n≧1) dissolved in a catholyte, an organic sulfur compound, a carbon-sulfur polymer ((C₂S_{f})ₙ: f=2.5 to 50, n≧2), or the like.

In one embodiment, the positive active material includes a coating layer. In another embodiment, the positive active material is a compound of active materials coated with a coating layer. The coating layer may include one coating compound selected from the group consisting of oxides, and hydroxides of a coating element, oxyhydroxide, oxycarbonate, and hydroxycarbonate of a coating element. The compound for the coating layer may either be amorphous or crystalline. Examples of suitable coating elements include Mg, Al, Co, K, Na, Ca, Si, Ti, V, Sn, Ge, Ga, B, As, Zr, and combinations thereof. The coating process may be any conventional process so long as it does not adversely impact the properties of the positive active material (e.g., spray coating, immersing). Such processes are well known to persons having ordinary skills in the art so a detailed description is not provided.

In one embodiment, the positive active material layer further includes a binder and a conductive material. The binder improves adhesion between the positive active material particles and adhesion between the positive active material particles to the current collector. Nonlimiting examples of suitable binders include, but are not limited to, polyvinylalcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubbers, acrylated styrene-butadiene rubbers, epoxy resins, and nylons.

The conductive material improves electrical conductivity of the negative electrode. Any electrically conductive material can be used as a conductive agent so long as it does not cause a chemical change. Nonlimiting examples of suitable conductive materials include natural graphite, artificial graphite, carbon black, acetylene black, ketjen black, polyphenylene derivatives, carbon fibers, metal powders or metal fiber including copper, nickel, aluminum, silver, and so on.

One nonlimiting example of a suitable current collector is Al.

The positive electrode may be fabricated by mixing a positive active material, a binder, and a conductive agent to form a positive active material composition, which is then coated on a current collector such as aluminum.

In one embodiment, the electrolyte includes a lithium salt dissolved in a non-aqueous organic solvent.

The lithium salt supplies lithium ions in the battery. It helps facilitating the basic operation of a rechargeable lithium battery and improves lithium ions transport between the positive and negative electrodes.

Nonlimiting examples of suitable lithium salts include LiPF₆, LiBF₄, LiSbF₆, LiAsF₆, LiClO₄, LiCF₃SO₃, LiC₄F₉SO₃, LiN(CF₃SO₂)₂, LiN(C₂F₅SO₂)₂, LiAlO₂, LiAlCl₄, LiN(CₚF₂ₚ₊₁SO₂)(C_{q}F_{2q+1}SO₂) (where p and q are natural numbers), LiCl, LiI, lithium bisoxalate borate, and combinations thereof.

The lithium salt may be used at a concentration ranging from 0.1 to 2.0 M. According to one embodiment, the lithium salt may be used at a concentration ranging from 0.7 to 1.6 M. When the lithium salt concentration is less than 0.1 M, the electrolyte performance may deteriorate due to low electrolyte conductivity. When the lithium salt concentration is more than 2.0 M, the lithium ion mobility may be reduced due to an increase in electrolyte viscosity.

The non-aqueous organic solvent acts as a medium for transmitting ions taking part in the electrochemical reaction of the battery. Nonlimiting examples of suitable non-aqueous organic solvents include carbonate-based, ester-based, ether-based, ketone-based, alcohol-based, and aprotic solvents. Nonlimiting examples of suitable carbonate-based solvents include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and butylene carbonate (BC). Nonlimiting examples of suitable ester-based solvents include n-methyl acetate, n-ethyl acetate, n-propyl acetate, dimethylacetate, methylpropionate, ethylpropionate, γ-butyrolactone, decanolide, valerolactone, mevalonolactone, caprolactone. Nonlimiting examples of suitable ether-based solvents include dibutyl ether, tetraglyme, diglyme, dimethoxyethane, 2-methyltetrahydrofuran, tetrahydrofuran. Nonlimiting examples of suitable ketone-based solvents include cyclohexanone. Nonlimiting examples of suitable alcohol-based solvents include ethyl alcohol, isopropyl alcohol. Nonlimiting examples of suitable aprotic solvents include nitrites such as X—CN (where X is a C2 to C20 linear, branched, or cyclic hydrocarbon, a double bond, an aromatic ring, or an ether bond), amides (such as dimethylformamide), dioxolanes (such as 1,3-dioxolane, sulfolanes).

The non-aqueous organic solvent may be a single solvent or a mixture of solvents. When the organic solvent is used in a mixture, the mixture ratio can be controlled according to the desired battery performance.

The carbonate-based solvents may include a mixture of a cyclic carbonate and a linear carbonate. The cyclic carbonate and chain carbonate can be mixed together in a volume ratio ranging from 1:1 to 1:9. When such a mixture is used as an electrolyte, electrolyte performance may be enhanced.

In one embodiment of the present invention, the electrolyte may further include a mixture of carbonate-based solvents and aromatic hydrocarbon-based solvents. The carbonate-based solvents and the aromatic hydrocarbon-based solvents are preferably mixed together in a volume ratio ranging from 1:1 to 30:1.

The aromatic hydrocarbon-based organic solvent may be represented by Formula 26.

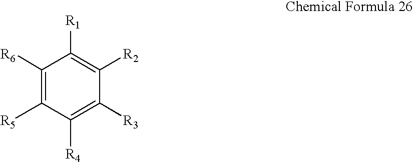

In Formula 26, each of R₁ through R₆ is independently selected from the group consisting of hydrogen, halogen, C1 to C10 alkyl, and C1 to C10 haloalkyl.

Nonlimiting examples of suitable aromatic hydrocarbon-based organic solvents include, but are not limited to, benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, and xylene.

The non-aqueous electrolyte may further include vinylene carbonate or an ethylene carbonate-based compound of the Formula 27.

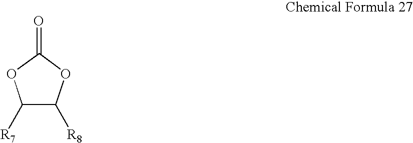

In Formula 27, each of the R₇ and R₈ groups is independently selected from the group consisting of hydrogen, halogen, cyano (CN), nitro (NO₂), and C1 to C5 fluoroalkyl. In one embodiment, both R₇ and R₈ cannot simultaneously be hydrogen.

Nonlimiting examples of suitable ethylene carbonate-based compounds include difluoroethylene carbonate, chloroethylene carbonate, dichloroethylene carbonate, bromoethylene carbonate, dibromoethylene carbonate, nitroethylene carbonate, cyanoethylene carbonate, and fluoroethylene carbonate. The amount of each of the additives for improving the cycle-life may be adjusted within an appropriate range.

The rechargeable lithium battery may further include a separator 113 between the negative electrode 112 and the positive electrode 114, as needed. The separator 113 separates the negative electrode 112 and positive electrode 114, and provides a path for transporting lithium ions. Nonlimiting examples of suitable separator 113 materials include polyethylene, polypropylene, polyvinylidene fluoride, and multi-layers thereof. Nonlimiting examples of suitable multilayer separators 113 include polyethylene/polypropylene double-layered separators, polyethylene/polypropylene/polyethylene triple-layered separators, and polypropylene/polyethylene/polypropylene triple-layered separators.

The following examples illustrate certain aspects of the present invention. These examples, however, are presented for illustrative purposes only and are not to be interpreted as limiting the scope of the invention.

### EXAMPLE 1

Monosilane gas and oxygen gas were mixed at a volume ratio of 1:1 and reacted at a pressure of 500 kPa and a temperature of 700° C. to produce a SiO_{0.5} negative active material having nano-grains.

80 wt % of the resulting active material, 10 wt % of SUPER P, and 10 wt % of a polytetrafluoroethylene binder were mixed in N-methylpyrrolidone as a solvent to produce a negative active material slurry. The negative active material slurry was coated on a copper foil current collector to produce a negative electrode.

### EXAMPLE 2

SiO and Si were each mounted in a separate target device at a mole ratio of 1:1. The device for depositing SiO was heated to a temperature of 1300° C. while the device for depositing Si was heated to a temperature of 2000° C. to provide a SiO_{0.5} negative active material on a substrate. The reaction bath was maintained under an atmosphere of argon gas and a pressure of 500 kPa.

A negative electrode was then prepared in accordance with the same procedure as in Example 1.

### COMPARATIVE EXAMPLE 1

A mixed powder of SiO₂ with Si at 1:1 was heated to 1100 to 1600° C. under an inert atmosphere and at a pressure to generate SiO gas and to precipitate powders on the substrate to produce a nano-grain SiOₓ (x=1) negative active material.

A negative electrode was then prepared in accordance with the same procedure as in Example 1.

### COMPARATIVE EXAMPLE 2

Amorphous SiO having an average number particle diameter of 6 μm was heated under an argon atmosphere at 1000° C. to provide a SiOₓ (x=1) negative active material. A negative electrode was then prepared in accordance with the same procedure as in Example 1.

### Analysis of Negative Active Material

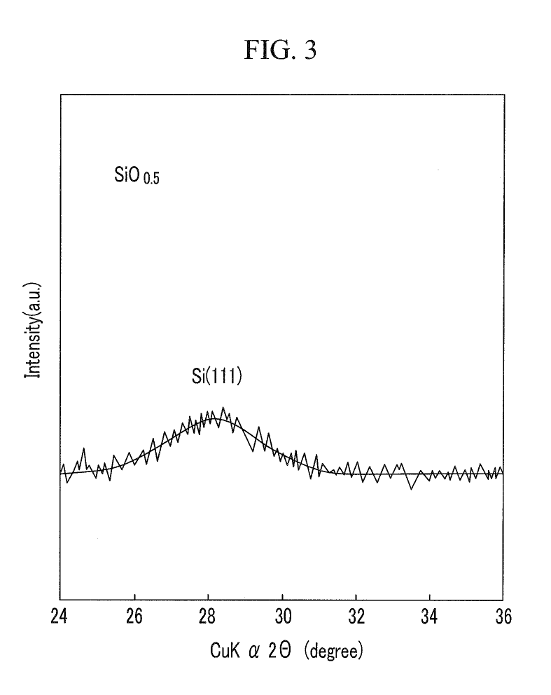

The active materials prepared according to Example 1 were tested using an X-ray diffraction analysis (Philips X'pert X-ray Diff.). The results are shown in FIG. 3.

The X-ray diffraction analysis was performed with a CuKα X-ray (1.5418 Å, 40 kV/30 mA), at a scan rate of 0.02°/second and within a range of 2θ.

FIG. 3 is a graph showing X-ray diffraction analysis results of the negative active materials prepared according to Example 1. From the results of the XRD measurement, the grain diameter (L) was calculated using the Scherrer Equation as shown in Equation 1:

L=0.94λ/H cos θ Equation 1

In the above equation, L is the grain diameter; λ is the wavelength; and H is the full width at half maximum (FWHM).

As shown in FIG. 3, the active material prepared from Example 1 includes nano-crystalline Si grains after completing the reaction. Further, the Si active material exhibits a Si(111) peak having FWHM of 1°.

### Analysis of Negative Active Material

The active materials prepared according to Examples 1 and 2, and Comparative Examples 1 and 2 were tested using X-ray diffraction analysis (Philips, X'pert X-ray Diff.) and Raman spectroscopic analysis to determine the Si(111) plane diffraction peak having FWHM and the Si-phase peak.

The X-ray diffraction analysis was performed with a CuKα X-ray (1.5418 Å, 40 kV/30 mA), at a scan rate of 0.02°/second and within a range of 2θ. The Raman spectroscopic analysis was conducted using a JY HR800 micro-Raman system (excitation source: argon 488 nm laser, CCD detector).

The average particle size and specific surface area of the negative active materials were measured, and the results are shown in Table 1.

TABLE 1

| | Si (111 peak) | Si-phase | Average | Specific |
|---|---|---|---|---|
| | FWHM | peak | particle size | surface area |
| | (°) | (cm⁻¹) | (μm) | (m²/g) |
| Example 1 | 0.5 | 480 | 5 | 6.5 |
| Example 2 | 0.5 | 480 | 5 | 7.0 |
| Comparative | 0.1 | 520 | 15 | 3.0 |
| Example 1 | | | | |
| Comparative | 0.05 | 520 | 5 | 7.0 |
| Example 2 | | | | |

### Analysis of Battery Cell Characteristics

The negative electrodes including negative active materials prepared according to Examples 1 and 2, and Comparative Examples 1 and 2 were then measured for electrochemical characteristics (initial efficiency and cycle-life characteristics).

Each of negative electrodes of Examples 1 and 2 and Comparative Examples 1 and 2 was used as a working electrode. A metal lithium foil was used as a counter electrode. A porous polypropylene film separator was inserted between the working electrode and the counter electrode, and an electrolyte solution of 1(mol/L) LiPF₆ dissolved in a 1:1:1 vol/vol/vol mixed solvent of propylene carbonate (PC), diethyl carbonate (DEC), and ethylene carbonate (EC) to produce a 2016 coin-type half cell.

The electrical characteristics of each cell were measured under a condition of between 0.005 and 2.0 V at a constant current of 0.1 C (for the first charge and discharge cycle). The cycle-life characteristic was determined by measuring the initial efficiency at the charge and discharge cycle and the initial capacity retention rate at the 50^{th} cycle. The results are shown in Table 2.

TABLE 2

| | Initial | Cycle-life characteristic |
|---|---|---|
| | efficiency (%) | (%) |
| Example 1 | 70 | 80 |
| Example 2 | 70 | 70 |
| Comparative Example 1 | 60 | 60 |
| Comparative Example 2 | 55 | 50 |

As shown in Table 2, the negative active materials of Examples 1 and 2 having nano-grain Si and amorphous silicon oxide have better the initial efficiency and cycle-life characteristics than those of Comparative Examples 1 and 2.

While this invention has been illustrated and described in connection with certain exemplary embodiments, it is understood by those of ordinary skill in the art that various modifications and changes may be made to the described embodiments without departing from the spirit and scope of the invention, which is also defined in the appended claims.

What is claimed is:

1. A negative active material for a rechargeable lithium battery, comprising a composite phase particle of the form SiOₓ, having a first crystalline phase of Si nano-grains and a second phase of non-crystalline SiO₂, wherein the composite phase particle has a Si-phase peak of 150 to 480 cm⁻¹ according to Raman spectroscopic analysis, and 0<x<1.

2. The negative active material of claim 1, wherein x is in the range of 0.2≦x≦0.8.

3. The negative active material of claim 1, wherein the negative active material has a Si(111) plane diffraction peak with a full width at half maximum (FWHM) of 0.5°(degrees) or more using an X-ray diffraction analysis (CuKα).

4. The negative active material of claim 1, wherein the negative active material has an average particle size ranging from 0.1 to 100 μm.

5. The negative active material of claim 1, wherein the negative active material has a specific surface area ranging from 1 to 100 m²/g.

6. A negative electrode for a rechargeable lithium battery, comprising
a current collector; and
an active material layer on the current collector, comprising a binder and a negative active material with a composite phase particle of the form SiOₓ, having a first crystalline phase of Si nano-grains and a second phase of non-crystalline SiO₂, wherein the composite phase particle has a Si-phase peak of 150 to 480 cm⁻¹ according to Raman spectroscopic analysis, and 0<x<1.

7. The negative electrode of claim 6, wherein x is in the range of 0.2≦x≦0.8.

8. The negative electrode of claim 6, wherein the negative active material has a Si(111) plane diffraction peak with a full width at half maximum (FWHM) of 0.5°(degrees) or more using an X-ray diffraction analysis (CuKα).

9. The negative electrode of claim 6, wherein the negative active material has an average particle size ranging from 0.1 to 100 μm.

10. The negative electrode of claim 6, wherein the negative active material has a specific surface area ranging from 1 to 100 m²/g.

11. A rechargeable lithium battery comprising:
a negative electrode with a negative active material comprising a composite phase particle of the form SiOₓ, having a first crystalline phase of a Si nano-grain and a second phase of non-crystalline SiO₂, wherein the composite phase particle has a Si-phase peak of 150 to 480 cm⁻¹ according to Raman spectroscopic analysis, and 0<x<1.

12. The rechargeable lithium battery of claim 11, wherein x is in the range of 0.2≦x≦0.8.

13. The rechargeable lithium battery of claim 11, wherein the negative active material has a Si(111) plane diffraction peak with a full width at half maximum (FWHM) of 0.5°(degrees) or more using an X-ray diffraction analysis (CuKα).

14. The rechargeable lithium battery of claim 11, wherein the negative active material has an average particle size ranging from 0.1 to 100 μm.

15. The rechargeable lithium battery of claim 11, wherein the negative active material has a specific surface area ranging from 1 to 100 m²/g.
